(19) United States
(12) Patent Application Publication
(10) Pub. No.: US 2009/0194200 A1
(43) Pub. Date: Aug. 6, 2009

(54) Coping Jig and Method

(76) Inventor: Haley Burch, Browns Summit, NC (US)

Correspondence Address: WILSON DANIEL SWAYZE, JR., 3804 CLEARWATER CT., PLANO, TX, 75025, US

(21) Appl. No.: 12/366,092

(22) Filed: Feb. 5, 2009

Related U.S. Application Data
(60) Provisional application No. 61/063,654, filed on Feb. 5, 2008.

(51) Int. Cl. B25H 1/00

(52) U.S. Cl. 144/286.1

(57) ABSTRACT

A coping table for coping a board may include a top clamping surface for clamping the coping table, a bottom surface for clamping to the board, and a top inclined surface being connected to the top clamping surface for cooperating with an electric jigsaw and being inclined with respect to the bottom surface. The top inclined surface may have a central access aperture to cooperate with the electric jigsaw to cut the board, and the top inclined surface may be connected to a shoulder surface. The shoulder surface may be connected to the top clamping surface, and the coping table may include a bottom inclined surface which is substantially parallel to the top inclined surface.

### PRIORITY

The present application claims priority under 35 USC section 119 and based upon a provisional application with a Ser. No. 61/063,654 which was filed on Feb. 5, 2008.

### FIELD OF THE INVENTION

The present invention relates to a coping table and more particularly to a coping table with an inclined surface.

### BACKGROUND OF THE INVENTION

A coping saw is a type of hand saw used to cut intricate external shapes and interior cutouts in woodworking or carpentry. It is widely used to cut moldings to create coped rather than miter joints. It is also occasionally used to create fretwork though it is not able to match a fretsaw in intricacy of cut, particularly in thin materials. Coping saw blades are thicker and much coarser cutting than typical fretsaw blades.

A coping saw includes a thin, hardened steel blade, stretched between the ends of a square, C-shaped, spring-steel frame to which a handle is attached. The blade is easily removed from the frame so that the blade can be passed through a drilled hole in the middle of a piece of wood. The frame is then re-attached to the blade and the cut starts from the middle of the piece. Long cuts parallel with the edge of the material are possible but the shallow depth of the frame rather limits how far from the edge one may cut. The much deeper frame of the fretsaw is more useful for cutting well away from the edge but conversely cannot manage the thicker materials commonly cut by the coping saw.

The coping saw blade is removable by partially unscrewing the handle. The blade is prevented from rotating by means of the short, steady bar provided where the blade is attached. Loosening the handle also allows the blade to be rotated relative to the frame as desired. Carefully aligning the finger steady bars at the top and bottom of the blade ensures that the thin blade is straight and not twisted along its length. Retightening the handle tensions the blade and locks it at the desired angle relative to the frame. The short steady bar nearest the handle is held securely between finger and thumb while the handle is tightened to ensure the blade remains at the desired angle. Unlike the fretsaw, the coping saw blade has holding pins which lock securely into the angled slots of the rotatable blade holders.

The direction of the cut is relatively easy to change because of the thinness of the blade. Gentle curves are achieved by slowly turning the whole frame by means of the handle while continuing to cut steadily. When necessary the blade can also be rotated with respect to the frame to make sharper curves in the material being cut. The teeth on a coping saw blade should normally face the handle. (i.e. “backwards” as compared with most other Western saws); the action of pulling the coping saw allows the frame to remain in tension (and thus reduces blade breakages). This is the opposite to most other saws which only cut in the “push” direction. Normally the coping saw is used in the vertical position and reciprocated by hand power for the maximum stroke possible without striking the material with the frame. It may also be used in all other attitudes when the work requires it but even greater skill is required. Blade breakage is fortunately much rarer than with a fretsaw.

The coping saw is a hand saw and consequently, using the coping saw requires a significant amount of manual dexterity and strength in order to perform a number of cuts or to use the coping saw for a significant amount of time.

### SUMMARY

A coping table for coping a board may include a top clamping surface for clamping the coping table, a bottom surface for clamping to the board, and a top inclined surface being connected to the top clamping surface for cooperating with an electric jigsaw and being inclined with respect to the bottom surface.

The top inclined surface may have a central access aperture with an electric jigsaw to cut the board, and the top inclined surface may be connected to a shoulder surface.

The shoulder surface may be connected to the top clamping surface, and the coping table may include a bottom inclined surface which is substantially parallel to the top inclined surface.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a a perspective view of a coping table which can be used with an electric jigsaw;

FIG. 2 illustrates a cross-sectional view of a side of the coping table;

FIG. 3 illustrates a cross-sectional view of a top of the coping table;

FIG. 4 illustrates a cross-sectional view of the front of the coping table.

### BRIEF DESCRIPTION

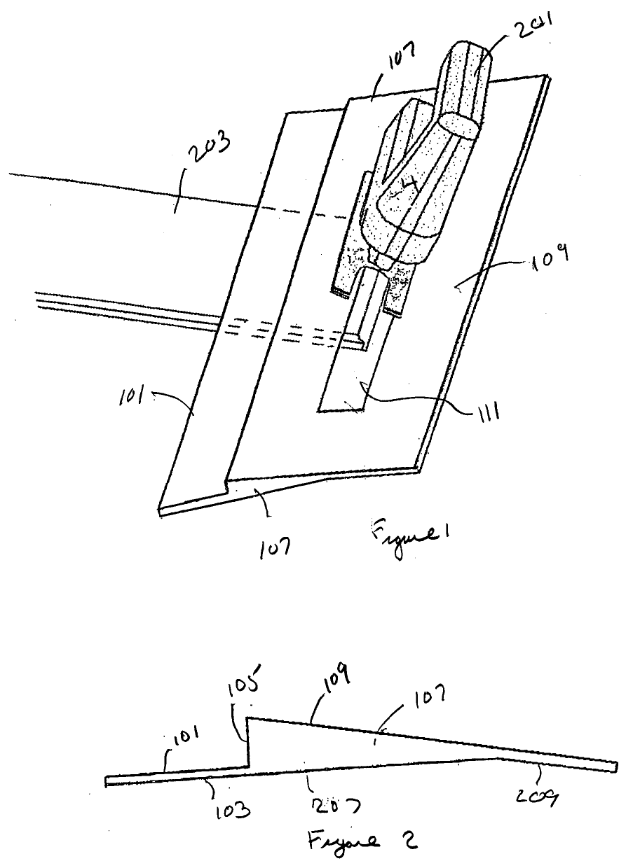

FIG. 1 illustrates a perspective view of the coping table 100 in operation with an electric jigsaw 201 (or other type of appropriate saw) which may cut a portion of wood such as a board 203. The use of the coping table 100 with the electric jigsaw 201 provides an advantage of achieving a cut through a board that might be achieved with a coping saw (not shown) but provides the speed and ease of use that is achievable with the electric jigsaw 201. The coping table 100 may include a rectangular profile or other profile such as circular, oval or other appropriate shape. The coping table 100 may be formed from rigid material such as metal, plastic or other suitable material in order to support a clamp (not shown) and to support the electric jigsaw 201. The coping table 100 may include a top clamping surface 101 at a distal end of the coping table 100 and may extend from the side surface 107 to the opposing side surface 107. The width of the top clamping surface 101 may be sufficient wide to accommodate a clamp such as a C clamp. Additionally, the coping table 100 may include a top inclined surface 109 which may provide a substantially flat surface in order to guide the electric jigsaw 201. The top inclined surface 109 may include a substantially central access aperture 111 which may extend through the coping table 100. The top inclined surface 109 may be formed at a substantially acute angle with respect to the top clamping surface 101 and with respect to the bottom clamping surface 103 and the top inclined surface 109 may be inclined such that the thickness of the coping table 100 is progressively reduced towards the proximate end of the coping table 100. The board 203 may be clamped to the bottom clamping surface 103 and may extend to the substantially central access aperture 111. The blade of the electric jigsaw 201 may extend through the substantially central access aperture 111 in order to cut the board 203.

FIG. 2 illustrates a side view of the coping table 100 and illustrates a shoulder surface 105 which may extend between the top clamping surface 101 and the top inclined surface 109. FIG. 2 additionally illustrates that the bottom clamping surface 103 is discontinuous and may include a first section 207 where the surface is substantially parallel to the top clamping surface 101 and may include a second section 209 where the surface is substantially parallel to the top inclined surface 109.

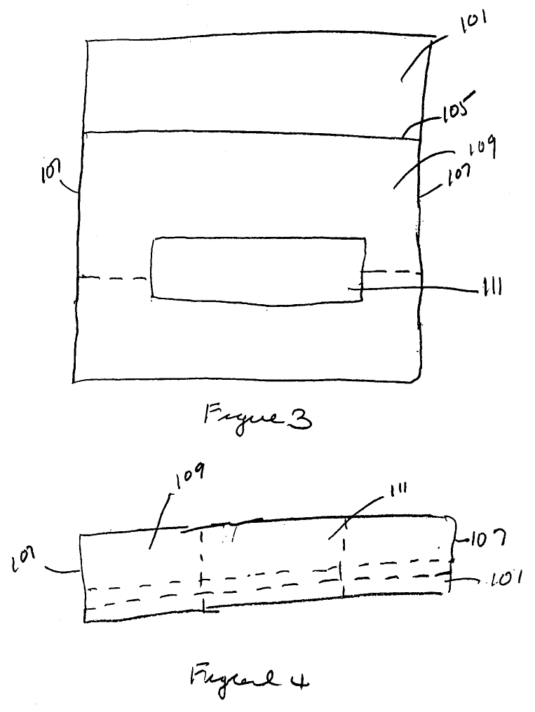

FIG. 3 illustrates a top view of the coping table 100 and illustrates the top clamping surface 101, the top inclined surface 109, the shoulder surface 105 and the side surface 107.

FIG. 4 illustrates a front view of the coping table 100 and illustrates the top clamping surface 101, the top inclined surface 109, and the central access aperture 111 and the side surface 107.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A coping table for coping a board, comprising:
a top clamping surface for clamping the coping table;
a bottom surface for clamping to the board;
a top inclined surface being connected to the top clamping surface for cooperating with an electric jigsaw and being inclined with respect to the bottom surface;
the top inclined surface having a central access aperture with to cooperate the electric jigsaw to cut the board.

2) A coping table for coping a board as in claim 1, wherein the top inclined surface is connected to a shoulder surface.

3) A coping table for coping a board as in claim 2, wherein the shoulder surface is connected to the top clamping surface.

4) A coping table for coping a board as in claim 1, wherein the coping table includes a bottom inclined surface which is substantially parallel to the top inclined surface.
